(19) United States
(12) Patent Application Publication
(10) Pub. No.: US 2013/0314581 A1
(43) Pub. Date: Nov. 28, 2013

(54) ELECTRONIC MIRROR DEVICE, ELECTRONIC MIRROR DISPLAY METHOD, AND ELECTRONIC MIRROR PROGRAM

(71) Applicant: SONY CORPORATION, Tokyo (JP)

(72) Inventor: ASUKA KIDO, Tokyo (JP)

(73) Assignee: SONY CORPORATION, Tokyo (JP)

(21) Appl. No.: 13/892,889

(22) Filed: May 13, 2013

(30) Foreign Application Priority Data
May 23, 2012 (JP) 2012-117163

(51) Int. Cl. H04N 5/232; G09G 5/10

(52) U.S. Cl. CPC H04N 5/23293; G09G 5/10
USPC 348/333.12; 345/589

(57) ABSTRACT

There is provided an electronic mirror device including a camera unit, a display unit, and a control unit that displays a screen image of a person captured by the camera unit on a first area obtained by splitting the screen of the display unit, displays a light source for lighting the person on a second area, and adjusts a brightness of the light source according to a sex and/or an age of the person detected by analyzing the screen image of the person.

### BACKGROUND

The present disclosure relates to an electronic mirror device, an electronic mirror display method, and an electronic mirror program, and in particular, to an electronic mirror device that may be used as a mirror for reflecting a user who is watching a television set when the television set is not used, an electronic mirror display method, and an electronic mirror program.

A television set using a flat-panel display device, when not used, is only a stationary article of a black board and otherwise has no special use. As for the television set, a multifunctional image display device is known that can be used as a mirror for another purpose when it is not used as a display device (see, for example, Japanese Patent Laid-Open No. 2006-126379). The multifunctional image display device includes a liquid display device and a half mirror, in which the half mirror normally operates as a mirror, and on detecting a person approaching, the liquid display device displays motion picture.

### SUMMARY

However, the half mirror has problems that: since setting the absorption rate to 0 gives the sum of the passing rate and reflection rate to 100% at most, when the multifunctional image display device is used as either of a liquid display device and a mirror, using one of the functions in a bright mode makes the other in a dark mode.

In view of the circumstances described above, there is a demand for an electronic mirror device that does not darken even when used as a mirror and makes the object rather look more beautiful than normal mirrors do, an electronic mirror display method, and an electronic mirror program.

According to an embodiment of the present disclosure, there is provided an electronic mirror device including a camera unit, a display unit, and a control unit that displays a screen image of a person captured by the camera unit on a first area obtained by splitting the screen of the display unit, displays a light source for lighting the person on a second area, and adjusts a brightness of the light source according to a sex and/or an age of the person detected by analyzing the screen image of the person.

Further, according to an embodiment of the present disclosure, there is provided an electronic mirror display method performed by a computer, the method including estimating a sex and/or an age of a person by analyzing a screen image of the person captured by a camera unit, splitting a screen of a display unit into a first area and second area to display the screen image of the person captured by the camera unit on the first area and display a white image on the second area, and adjusting a brightness of the white image according to the estimated sex and/or the estimated age.

Further, according to an embodiment of the present disclosure, there is provided an electronic mirror program that causes a computer to execute processing including estimating a sex and/or an age of a person by analyzing a screen image of the person captured by a camera unit, splitting a screen of a display unit into a first area and second area to display the screen image of the person captured by the camera unit on the first area and display a white image on the second area, adjusting a brightness of the white image according to the estimated sex and/or the estimated age, removing a background by cutting the image of the person out of the screen image captured by the camera unit, inverting left and right sides of the screen image captured by the camera unit, adjusting an image quality of the screen image captured by the camera unit, and setting the background removal, the inversion of the left and right sides, and the adjustment of the image quality.

According to the present disclosure, a screen image of a person captured by the camera unit is displayed on a first area obtained by splitting the screen of the display unit, a second area is used for a light source for lightening, and the brightness of the light source is adjusted according to the sex and/or age detected by analyzing the screen image of the person. By this, there is a merit that a television set may be used effectively as an electronic mirror device when not in use and may record and beautifully display a person without preparing any special lightning apparatus since the second area is used as a light source for lightening an object.

### BRIEF DESCRIPTION OF THE DRAWINGS

FIG. 1 is a functional block diagram showing a configuration example of an electronic mirror device according to an embodiment of the present technology;

FIG. 2 is a functional block diagram showing a configuration example of an image analyzing and processing unit;

FIG. 3 is an external view of a television set as an exemplary application of the electronic mirror device;

FIG. 4 is a diagram of the control characteristic of a light source control unit;

FIG. 5 is a diagram of an exemplary setting in a setting unit;

FIG. 6 is a diagram of an exemplary hardware configuration of the television set used in the embodiment;

FIG. 7 is a flowchart showing a flow of an electronic mirror program; and

FIG. 8 is a diagram of an exemplary variant of the electronic mirror device.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

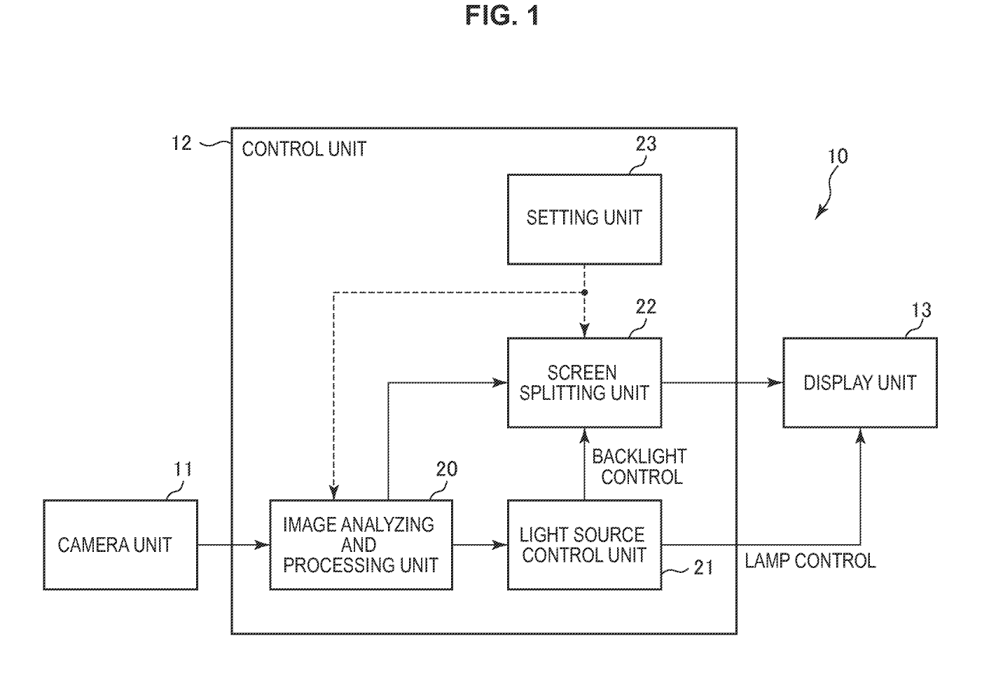

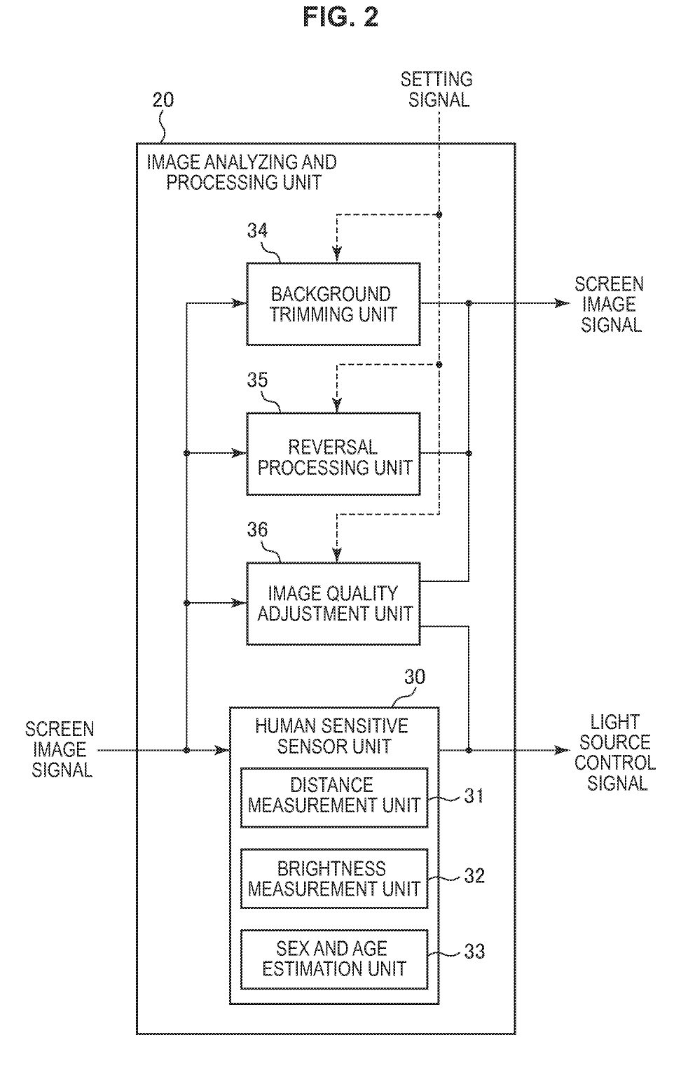

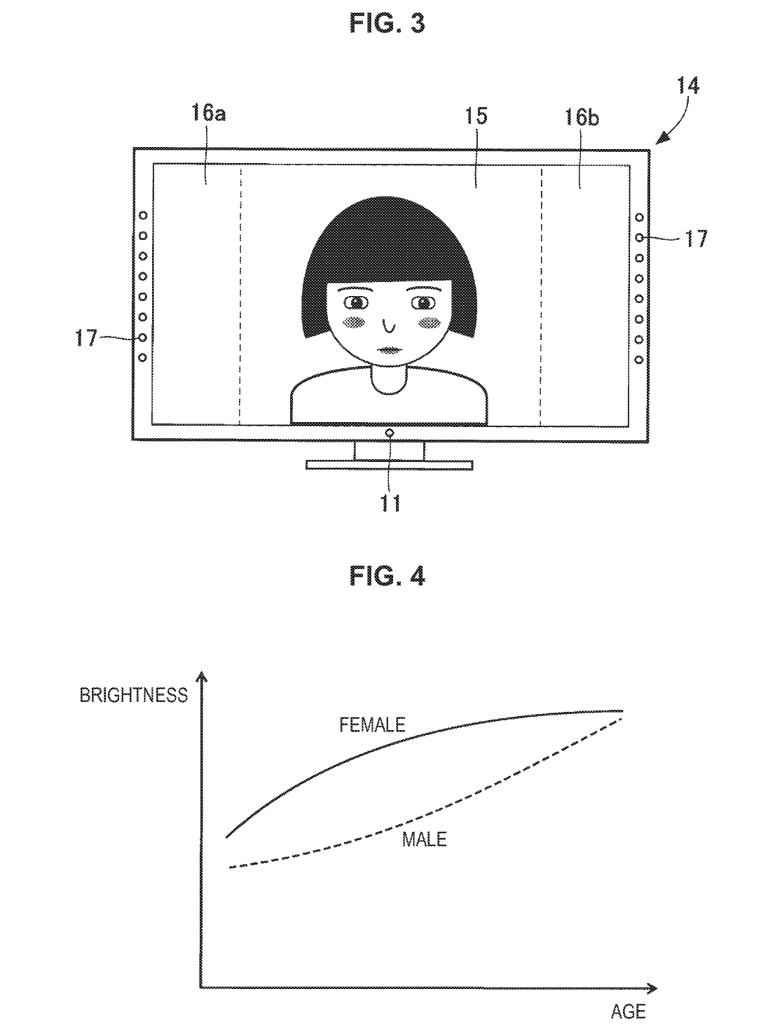

FIG. 1 is a functional block diagram showing a configuration example of an electronic mirror device according to an embodiment of the present disclosure; FIG. 2 is a functional block diagram showing a configuration example of an image analyzing and processing unit; and FIG. 3 is an external view of a television set as an exemplary application of the electronic mirror device.

An electronic mirror device 10 includes, as shown in FIG. 1, a camera unit 11 for recording a person to output screen image signals of the person, a control unit 12 for controlling the function of an electronic mirror based on the screen image signals, and a display unit 13 for displaying the captured screen image. Here, as a preferable example, the display unit 13 corresponds to a display panel of a television set 14 as shown FIG. 3, the camera unit 11 is provided as a human sensitive sensor on a frame part of the television set 14, and the control unit 12 is part of the control unit of the television set 14. The television set 14 has a screen that is split into a first area 15 located at the center of the screen and second areas 16a and 16b located at the left and right sides of the first area 15, respectively. The first area 15 displays an image captured by the camera unit 11, and the second areas 16a and 16b are used as light sources for lighting a person. A plurality of indicator lamps 17 are provided on a frame part of the television set 14 for displaying various operations, and the indicator lamps 17 are also used as part of light source for lighting a person.

The control unit 12, as shown in FIG. 1, has an image analyzing and processing unit 20 for taking a screen image signal from the camera unit 11. The image analyzing and processing unit 20 has an output connected to a light source control unit 21 and a screen splitting unit 22. The light source control unit 21 outputs signals for controlling backlight to the screen splitting unit 22, and the screen splitting unit 22 outputs to the display unit 13 screen images processed by the image analyzing and processing unit 20 and screen light without a certain image at the brightness indicated by the light source control unit 21. The light source control unit 21 also outputs to the display unit 13 signals for controlling the indicator lamp 17 provided in the display unit 13.

The control unit 12 also has a setting unit 23. For the screen splitting unit 22, the setting unit 23 sets the location of the first area 15 and second areas 16a and 16b in the entire screen or the split ratio of the first area 15 and second areas 16a and 16b, for example. In addition, for the image analyzing and processing unit 20, the setting unit 23 sets how the first area 15 displays a person. For example, the setting unit 23 may set whether the background of the person is necessary and which type of mirror to be implemented: a reversal mirror that displays a view from another person or a normal mirror displaying the view with left and right sides inverted. The setting unit 23 may also set the image quality of the screen image of a person displayed on the first area 15 to the taste of the user. For the image quality, the image analyzing and processing unit 20 may perform adjustment by processing the signal of images captured by the camera unit 11 or adjusting the emission color or the brightness of the second areas 16a and 16b and indicator lamp 17.

The image analyzing and processing unit 20, as shown in FIG. 2, includes a human sensitive sensor unit 30. The human sensitive sensor unit 30 includes a distance measurement unit 31, a brightness measurement unit 32 and a sex and age estimation unit 33. The distance measurement unit 31 measures the distance from the camera unit 11 to the user when the image of the person's face is included in a screen image signal from the camera unit 11. The brightness measurement unit 32 measures the brightness of an environment in which the television set 14 is installed. The sex and age estimation unit 33 estimates the sex and age of the user by recognizing from an image of the face, for example, the spacing between his/her eye, nose, and mouth or the surface condition of his/her skin. The result of the measurement and estimation by the human sensitive sensor unit 30 is passed to the light source control unit 21. Here, since the sex and age estimation unit 33 performs face recognition, it may be detected whether the user is facing the front of the camera unit 11. In this embodiment, the detection result is added to the activation condition of the electronic mirror device 10.

The image analyzing and processing unit 20 also includes a background trimming unit 34, a reversal processing unit 35 and an image quality adjustment unit 36. The background trimming unit 34 removes a background by cutting the image of a person from a screen image captured by the camera unit 11 according to a parameter set by the setting unit 23, and the result of this process is passed to the screen splitting unit 22. The reversal processing unit 35 inverts the left and right sides of a screen image captured by the camera unit 11 according to a parameter set by the setting unit 23, and the result of this process is passed to the screen splitting unit 22. The image quality adjustment unit 36 adjusts the image quality of a screen image captured by the camera unit 11 according to a parameter set by the setting unit 23. The image quality may be adjusted by directly processing a screen image captured by the camera unit 11 or by modifying the emission color or brightness on the light source side including the second areas 16a and 16b and indicator lamp 17. The processing result of the image quality adjustment unit 36 is passed to the light source control unit 21 and screen splitting unit 22.

FIG. 4 is a diagram of the control characteristic of a light source control unit.

In the control characteristic illustrated in FIG. 4, the horizontal axis represents the change in an age and the vertical axis represents the change in a brightness of the second areas 16a and 16b to be controlled by the light source control unit 21.

The electronic mirror device 10 is basically designed so that a screen image captured by the camera unit 11 is displayed without modification on the first area 15 of the display unit 13 and the brightness of the second areas 16a and 16b is adjusted according to the sex and age of the user thereby making the screen image look beautiful. Thus, the light source control unit 21 sends a backlight control signal to the screen splitting unit 22 to modify the brightness of the second areas 16a and 16b according to the sex and age estimated by the sex and age estimation unit 33. In the example of FIG. 4, the brightness of the second areas 16a and 16b is set low with less relevance to the sex for younger age. Although the higher the age becomes, the higher the brightness is modified for both men and women, the brightness is set higher for women than men, and the change rate of the brightness is set higher for younger age than older age. Here, though the brightness of the second area 16a and 16 is adjusted according to the characteristic in FIG. 4, it is also slightly adjusted according to the measurement result of the distance measurement unit 31 and brightness measurement unit 32.

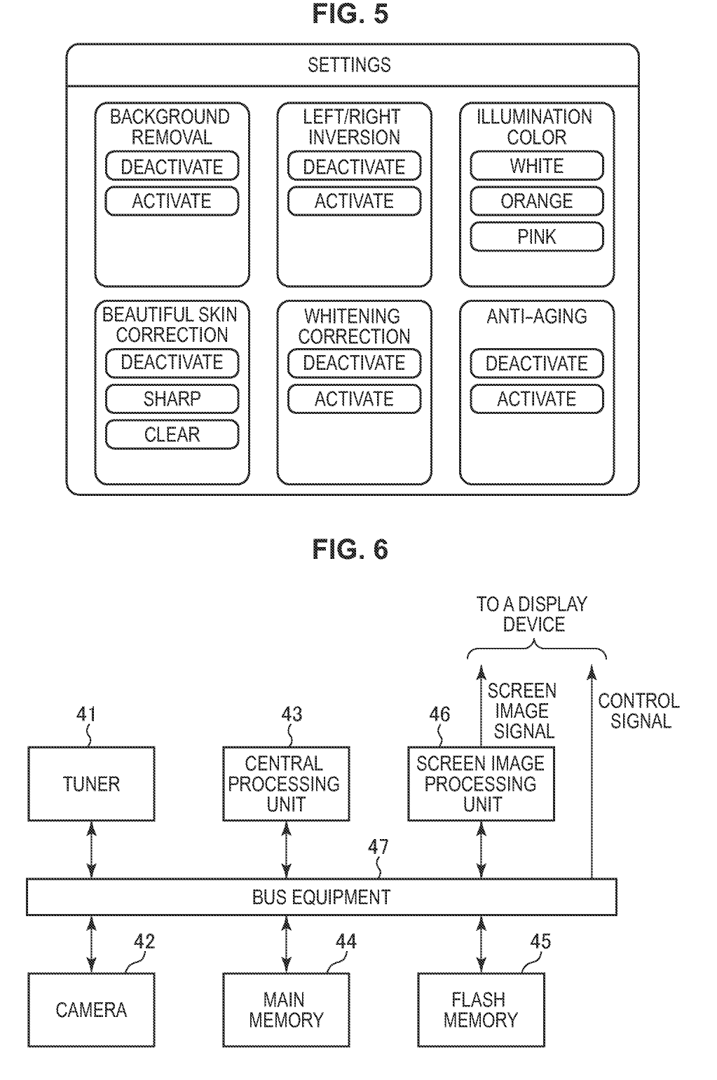

FIG. 5 is a diagram of an exemplary setting in a setting unit.

Although the electronic mirror device 10 displays without modification a screen image captured by the camera unit 11 on the first area 15 of the display unit 13, the taste of a user about the visibility of the screen image may be set by the setting unit 23 in advance. In this embodiment, background removal, left/right inversion, illumination color, beautiful skin correction, whitening correction and anti-aging may be set as alternatives that may be set with the setting unit 23.

The background removal is set when the user wishes to remove a background and display only a portrait of a person. If the background removal is activated, the background trimming unit 34 removes the background. The left/right inversion is set when the user wishes that display like a mirror image would be made. If the left/right inversion is activated, the reversal processing unit 35 inverts the left and right sides of an image. The illumination color is set when the user wishes to make a skin color warmer. Here, if the color is set to “orange” or “pink”, the image quality adjustment unit 36 performs adjustment so that the second areas 16a and 16b become “orange” or “pink”. Alternatively, the image quality adjustment unit 36 may keep white the emission color of the second areas 16a and 16b and adjust the brightness of the indicator lamp 17 to adjust the illumination color with use of the emission color of the indicator lamp 17. The beautiful skin correction is set when the user wishes to display so that skin firmness and moisture is maintained. Here, if “sharp” or “clear” is set, the image quality adjustment unit 36 processes an image for a screen image signal so that the image looks “sharp” or “clear”. The whitening correction is set when the user wishes to obscure flecks, freckles, or suntans. If the whitening correction is activated, the image quality adjustment unit 36 processes an image in order to obscure flecks etc. The anti-aging is set when the user wishes that he/she would look younger than the actual age on a display. If the anti-aging is activated, the image quality adjustment unit 36 processes an image in order to obscure wrinkles, for example.

FIG. 6 is a diagram of an exemplary hardware configuration of the television set used in the embodiment.

A television set 14 includes a tuner 41, a camera 42, a central processing unit 43, a main memory 44, a flash memory 45, and a screen image processing unit 46, which are interconnected by bus equipment 47. The screen image processing unit 46 and the bus equipment 47 are connected to a display device (not shown).

The tuner 41 is a unit for receiving telecast. The camera 42 is an imaging element corresponding to the camera unit 11 described above. The central processing unit 43, the main memory 44, the flash memory 45, the screen image processing unit 46, and the bus equipment 47 constitute a similar configuration to a computer. That is, the central processing unit 43 controls the entire unit of the television set 14. The main memory 44 temporally stores programs of an OS (operating system) or at least some of application programs which the central processing unit 43 executes. Additionally, the main memory 44 stores various data necessary for the processing by the central processing unit 43. The flash memory 45 stores various application programs including the OS and an electronic mirror program, and various settings information. The screen image processing unit 46 is connected to a display device, and according to instructions from the central processing unit 43, sends to the display device a screen image signal obtained by processing a screen image to display on the screen of the display device.

The above hardware configuration provides the processing functions of the embodiment. A process of an electronic mirror program stored in the flash memory 45 will now be described.

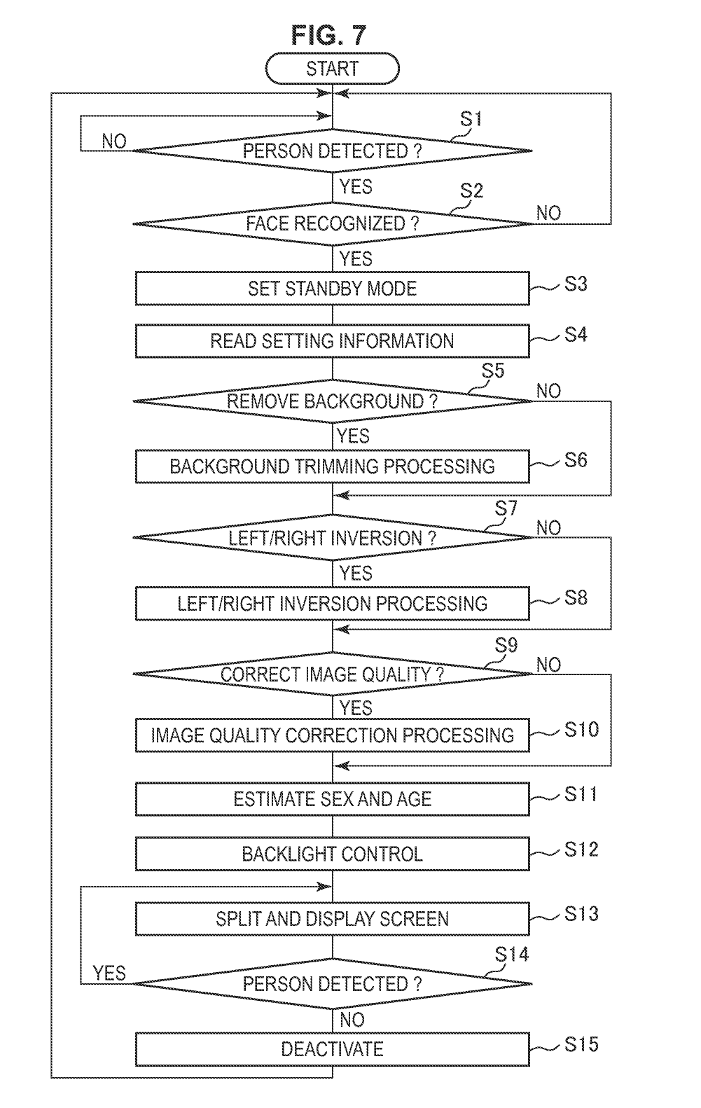

FIG. 7 is a flowchart showing a flow of an electronic mirror program.

The central processing unit 43 determines whether a person is detected within a predetermined distance during the monitoring by the camera 42 (step S1). Here, when the person is detected, the central processing unit 43 determines whether a face is recognized (step S2). When the face is recognized, preferably the direction of the face is also determined. Here, when the face is recognized and facing the front of the camera 42, the central processing unit 43 set the display device to a standby mode (step S3) and reads various setting information (step S4).

Next, the central processing unit 43 determines whether there is any background removal setting in the setting information (step S5), and if there is any background removal setting, performs a trimming process for removing a background (step S6), and if there is not any background removal setting, skips the processing of the step S6.

Next, the central processing unit 43 determines whether there is any left/right inversion setting in the setting information (step S7), and if there is any left/right inversion setting, inverts the left and right sides of a screen image (step S8), and if there is not any left/right inversion setting, skips the processing of the step S8.

Next, the central processing unit 43 determines whether there is any image quality correction setting in the setting information about illumination color, beautiful skin correction, whitening correction or anti-aging (step S9), and if there is any image quality correction setting, corrects the image quality (step S10), and if there is not any image quality correction setting, skips the processing of the step S10.

Next, the central processing unit 43 estimates the sex and age of a person from a screen image signal from the camera 42 (step S11) and controls backlight according to the sex and age (step S12). Next, the central processing unit 43 splits the screen into the screen image from the camera 42 and backlight-controlled screen light without a certain image for lightning and displays them on the display device (step S13).

Next, the central processing unit 43 determines whether the camera 42 is detecting a person within a predetermined distance (step S14) and, as long as the camera 42 is detecting the person, continues the screen splitting. When the camera 42 does not detect the person within a predetermined distance, the central processing unit 43 deactivates the display device (step S15) and returns to the step S1.

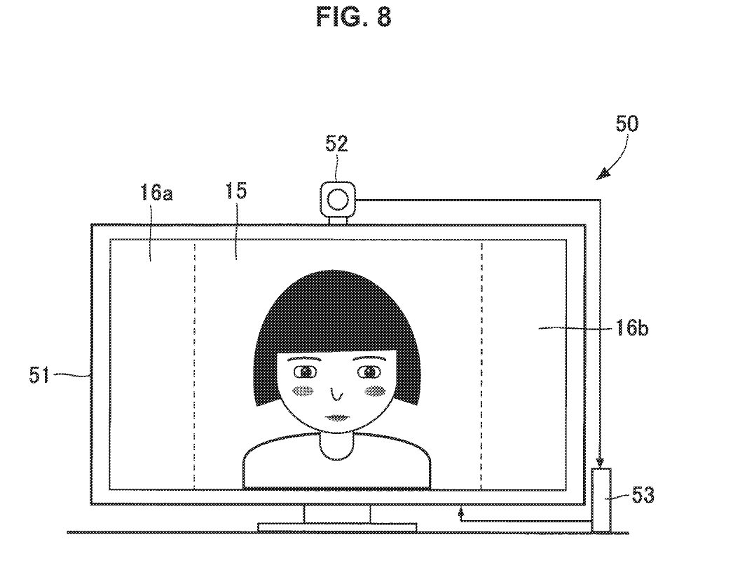

FIG. 8 is a diagram of an exemplary variant of the electronic mirror device.

An electronic mirror device 50 shown in FIG. 8 includes a general television set 51, a general video camera 52, and an electronic mirror control device 53. A camera such as a web camera may be used for the video camera 52, which is attached to the television set 51 for use. The electronic mirror control device 53 has, for example, a function of the control unit 12 shown in FIG. 1 but has no lamp control by the light source control unit 21. The screen image output of the video camera 52 is input to the electronic mirror control device 53; the screen image output of the electronic mirror control device 53 is connected to an external screen image input of the television set 51.

The electronic mirror control device 53 of the electronic mirror device 50 has a limitation that it is difficult to control the lamp emission from the indicator lamp 17, unlike the electronic mirror device 10 integrally embedded in the television set 14 as shown in FIG. 3. In addition, the electronic mirror control device 53 may not analyze a screen image of the video camera 52 and control the television set 51 according to whether the person is detected. However, when the user already owns the television set 51 and video camera 52, the electronic mirror device 50 can easily be configured by connecting the electronic mirror control device 53 to the television set 51 and video camera 52.

Although the general television set 51 is used for a display device in this electronic mirror device 50, since the purpose of this is to display screen images captured by the video camera 52, a video monitor device may be used in place of the television set 51.

Note that, in the above embodiment, the screen of the display unit 13 is split so that the second areas 16a and 16b are arranged on the left and right sides of the first area 15, respectively. However, the second areas 16a and 16b used as a lightning area may be arranged not only on the left and right sides of the first area 15 but on the top and bottom sides of the first area 15 or on the left, right, top and bottom sides of the first area 15 so that they surround the first area 15.

Additionally, although the television set 14 and 51 with internal or external camera capability is used in the above embodiment, an electronic mirror device may be implemented by installing the above electronic mirror program into a tablet with camera capability embedded therein.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2012-117163 filed in the Japan Patent Office on May 23, 2012, the entire content of which is hereby incorporated by reference.

What is claimed is:

1. An electronic mirror device comprising:
a camera unit;
a display unit; and
a control unit that displays a screen image of a person captured by the camera unit on a first area obtained by splitting the screen of the display unit, displays a light source for lighting the person on a second area, and adjusts a brightness of the light source according to a sex and/or an age of the person detected by analyzing the screen image of the person.

2. The electronic mirror device according to claim 1, wherein the second area is arranged in left and right sides, top and bottom sides, or left, right, top and bottom sides of the first area.

3. The electronic mirror device according to claim 1, wherein the control unit includes a function for removing a background by cutting an image of the person out of the screen image captured by the camera unit.

4. The electronic mirror device according to claim 1, wherein the control unit has a function of inverting left and right sides of the screen image captured by the camera unit.

5. The electronic mirror device according to claim 1, wherein the control unit has a function of modifying an emission color of the light source of the second area to adjust an image quality of the screen image captured by the camera unit.

6. The electronic mirror device according to claim 1, wherein the control unit has a function of modifying a brightness of a lamp provided in the display unit to adjust an image quality of the screen image captured by the camera unit.

7. The electronic mirror device according to claim 1, wherein the control unit has a function of adjusting an image quality of the screen image captured by the camera unit.

8. The electronic mirror device according to claim 1, wherein the control unit has a function of detecting a distance from the camera unit to a person and a direction of a face based on a screen image of the person captured by the camera unit, and performing screen display on the display unit when the distance is less than a predetermined distance and the face is facing front toward the camera unit.

9. The electronic mirror device according to claim 1, wherein the display unit is a television set with the camera unit and the control unit embedded therein.

10. An electronic mirror display method performed by a computer, the method comprising:
estimating a sex and/or an age of a person by analyzing a screen image of the person captured by a camera unit;
splitting a screen of a display unit into a first area and second area to display the screen image of the person captured by the camera unit on the first area and display a white image on the second area; and
adjusting a brightness of the white image according to the estimated sex and/or the estimated age.

11. An electronic mirror program that causes a computer to execute processing including:
estimating a sex and/or an age of a person by analyzing a screen image of the person captured by a camera unit;
splitting a screen of a display unit into a first area and second area to display the screen image of the person captured by the camera unit on the first area and display a white image on the second area;
adjusting a brightness of the white image according to the estimated sex and/or the estimated age;
removing a background by cutting the image of the person out of the screen image captured by the camera unit;
inverting left and right sides of the screen image captured by the camera unit;
adjusting an image quality of the screen image captured by the camera unit; and
setting the background removal, the inversion of the left and right sides, and the adjustment of the image quality.
